(19) United States
(12) Patent Application Publication
(10) Pub. No.: US 2013/0315365 A1
(43) Pub. Date: Nov. 28, 2013

(54) METHOD AND APPARATUS FOR A JET PUMP INLET-MIXER SLIP JOINT

(71) Applicants: Catherine Procik Dulka, Exton, PA (US); Henry P. Offer, San Jose, CA (US); Mark O. Lenz, San Jose, CA (US); Elizabeth B. Umhoefer, Wilmington, NC (US); Mark S. Godfrey, Willimington, NC (US)

(72) Inventors: Catherine Procik Dulka, Exton, PA (US); Henry P. Offer, San Jose, CA (US); Mark O. Lenz, San Jose, CA (US); Elizabeth B. Umhoefer, Wilmington, NC (US); Mark S. Godfrey, Willimington, NC (US)

(73) Assignee: GE-HITACHI NUCLEAR ENERGY AMERICAS LLC, Wilmington, NC (US)

(21) Appl. No.: 13/478,721

(22) Filed: May 23, 2012

(51) Int. Cl. G21C 15/00; B23P 15/00

(52) U.S. Cl. 376/372; 29/888.02

(57) ABSTRACT

A slip joint of the jet pump assembly inlet-mixer is the interface between a diffuser and an inlet-mixer. The diffuser is coated with a first hardfacing alloy, and the inlet-mixer is coated with a second hardfacing alloy different from the first hardfacing alloy. The first hardfacing alloy may be a cobalt-based alloy and the second hardfacing alloy may be a cobalt-free alloy, i.e., at least one of an iron-based and nickel-based hardfacing alloy.

### BACKGROUND

1. Field of the Invention

Example embodiments relate generally to nuclear reactors, and more particularly to a method and apparatus for a Boiling Water Reactor (BWR) jet pump inlet-mixer/diffuser slip joint including at least two different materials, one of which is a cobalt-free material.

2. Related Art

A reactor pressure vessel (RPV) of a boiling water reactor (BWR) typically has a generally cylindrical shape and is closed at both ends (for example by a bottom head and a removable top head). A top guide typically is spaced above a core plate within the RPV. A core shroud, or shroud, typically surrounds the core and is supported by a shroud support structure. Particularly, the shroud has a generally cylindrical shape and surrounds both the core plate and the top guide. There is a space or annulus between the cylindrical reactor pressure vessel and the cylindrically shaped shroud.

In a BWR, a number of hollow tubular jet pumps positioned within the shroud annulus provide the required reactor core coolant and/or water flow. The jet pump assembly includes a riser, two inlet-mixers, and two diffusers. The riser and the two diffusers are permanently installed in the shroud annulus. The inlet-mixers are removable components. The entrance of the inlet-mixer is positioned in the top of the riser. The exit end of the inlet-mixer fits into a close fitting slip joint, formed with the top of the diffuser. The slip joint allows for differential thermal expansion between the jet pump assembly and the RPV, while minimizing or reducing leakage from the jet pump assembly. The interfacing surfaces of the inlet-mixer and diffuser, which form the slip joint, are protected from in-service wear by a hardfacing alloy applied to both components.

A conventional hardfacing alloy, i.e., Stellite® 6 (manufactured by Deloro Stellite Group), may be applied at this location to mitigate any wear that may occur at the actual interface between the inlet-mixer and the diffuser. The Stellite® 6 alloy is a cobalt-based alloy, which consists of about 62-65 wt % cobalt (Co). The Stellite® 6 alloy is widely used in reactor environments due to its desirable wear-resistance properties, ability to withstand relatively high temperatures, pressures and water environments without corroding or cracking.

However, the relatively large amount of cobalt used in the Stellite® 6 alloy causes localized “hot” spots within the reactor, and allows for activated cobalt to spread through the rest of the nuclear plant. In addition, as the Stellite® 6 alloy interacts with the reactor, relatively fine bits of the material may be worn away and scattered throughout the rest of the reactor, causing a higher activation of cobalt in other areas of the plant.

Also, conventional hardfacing alloys such as the Stellite® 6 alloy may expose plant maintenance personnel to ionizing radiation from cobalt (Co)-60 corrosion products, and higher costs are associated with conventional hardfacing alloys in decontaminating recirculation piping and other components of the BWR.

### SUMMARY

Example embodiments provide an apparatus for a slip joint of a jet pump inlet-mixer. Example embodiments provide a slip joint including at least two different hardfacing materials, one of which is a cobalt-free material. The slip joint is the interface between the inlet-mixer and the diffuser. The diffuser is coated with a first hardfacing alloy, and the inlet-mixer is coated with a second hardfacing alloy different from the first hardfacing alloy.

### BRIEF DESCRIPTION OF THE DRAWINGS

The above and other features and advantages of example embodiments will become more apparent by describing in detail, example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a perspective view of a boiling water nuclear reactor (BWR) jet pump assembly, in accordance with an example embodiment;

FIG. 2 is a detailed external view of an interface that exists between an inlet-mixer and a diffuser of a BWR jet pump assembly, in accordance with an example embodiment; and

FIG. 3 is a cross-sectional view of an interface illustrating a slip joint that exists between an inlet-mixer and a diffuser of a BWR jet pump assembly, in accordance with an example embodiment.

### DETAILED DESCRIPTION

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

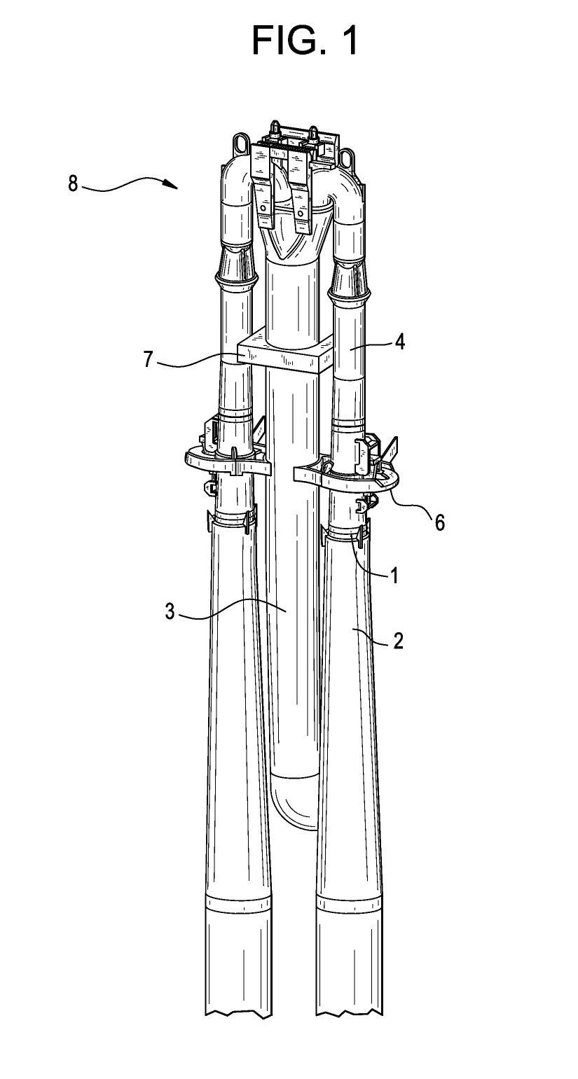

FIG. 1 is a perspective view of a nuclear boiling water reactor (BWR) jet pump assembly 8, according to an example embodiment. The major components of the jet pump assembly 8 include a slip joint 1, a riser 3, two inlet-mixers 4 that are inserted into respective diffusers 2, jet pump restrainer brackets 6 and a riser brace 7. The jet pump restrainer brackets 6 provide lateral support to the inlet-mixers 4, and the riser brace 7 provides lateral support to the riser 3.

The slip joint 1 is at the interface between the inlet-mixer and diffuser. The interface surface of the diffusers 2 are coated with a first hardfacing alloy, i.e., a cobalt-based alloy, and the two inlet-mixers 4 are coated with a second hardfacing alloy, i.e., a cobalt-free alloy. A cobalt-free alloy is defined as an alloy containing either no cobalt or less than 0.2 wt % of cobalt. The second hardfacing alloy may be coated on the interface surface of the two inlet-mixers 4 via a plasma arc transfer (PTA) welding method. The cobalt-based alloy of the diffusers 2 may be any one of several Stellite® alloys (manufactured by Deloro Stellite Group), but is not limited thereto. For example, the cobalt-based alloy may be a Stellite® 6 alloy.

The cobalt-free alloy of the two inlet-mixers 4 may be one of an iron-based or nickel-based alloy. The iron-based alloy of the two inlet-mixers 4 may be any one of several NOREM™ alloys and/or a Tristelle™ alloy (manufactured by ASM International), but is not limited thereto. For example, the iron-based alloy may be NOREM™ 02 and/or Tristelle™ 5183. The NOREM™ 02 alloy includes about 60 wt % iron (Fe), and the Tristelle™ 5183 alloy includes about 55 wt % Fe. The nickel-based alloy of the two inlet-mixers 4 may be any one of several Nucalloy® alloys (manufactured by Deloro Stellite Group) and/or one of several Colmonoy® alloys (manufactured by Wall Colmonoy Corporation), but is not limited thereto. For example, the nickel-based alloy may be Nucalloy® 488, Colmonoy® 5 PTA, and/or Colmonoy® 84 PTA. The Nucalloy® 453 alloy includes about 78 wt % nickel (Ni), the Colmonoy® 5 PTA alloy includes about 75 wt % Ni, and the Colmonoy® 84 PTA alloy includes about 55 wt % Ni.

The cobalt-free alloy coated on the two inlet-mixers 4 will function similar to a Stellite® 6 alloy, because the cobalt-free alloy has a similar hardness value, and a similar ability to resist wear, corrosion and impact of the two inlet-mixers 4. Furthermore, the cobalt-free alloy may be easily welded to the two inlet-mixers 4 of the slip joint 1, and similarly resistant to stress corrosion cracking.

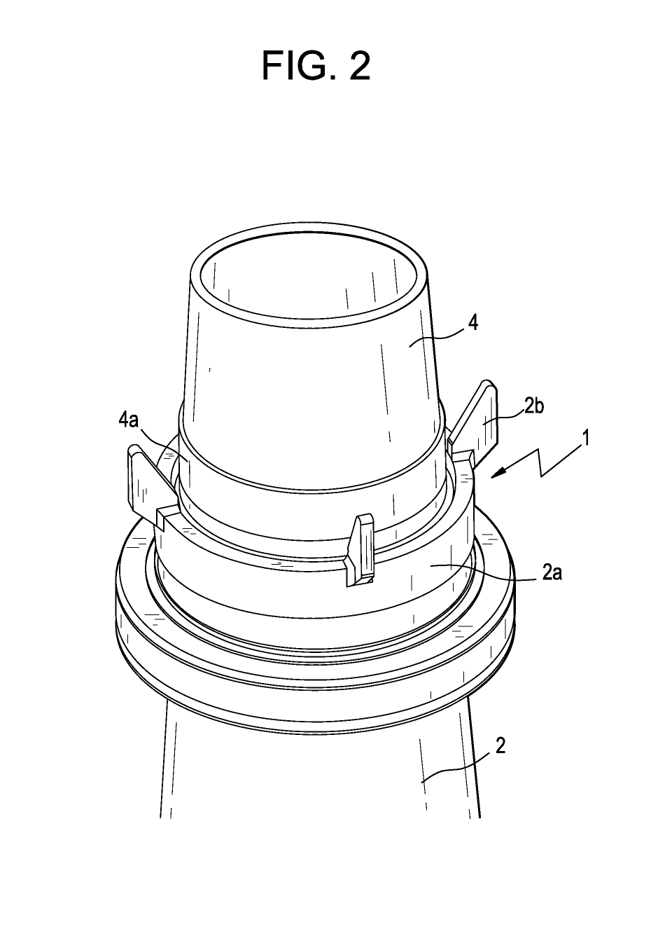

FIG. 2 is a detailed external view of an interface that exists between an inlet-mixer 4 and a diffuser 2 of a BWR jet pump assembly, according to an example embodiment. It should be noted that the bottom portion 4a of the inlet-mixer 4 inserts into the upper crown 2a of the diffuser 2 (which also includes guide ears 2b). The interface between the inlet-mixer 4 and the diffuser 2 is referred to as a “slip joint” 1.

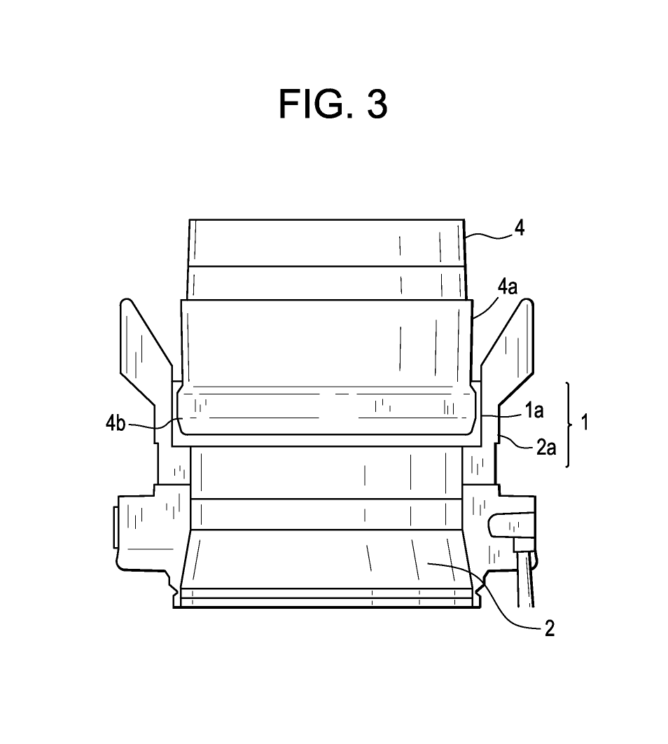

FIG. 3 is a cross-sectional view of a slip joint 1 that exists between an inlet-mixer 4 and a diffuser 2 of a BWR jet pump assembly, according to an example embodiment. The outer surface 4b of the inlet-mixer and the close fitting inner surface 1a of the diffuser form the slip joint 1. The close fitting inner surface 1a is coated with a first hardfacing alloy, i.e., a cobalt-based alloy, and the outer surface 4b is coated with a second hardfacing alloy, i.e., a cobalt-free alloy.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A slip joint of a jet pump inlet-mixer for a boiling water reactor (BWR) jet pump assembly comprising:
a diffuser having a surface coated with a first hardfacing alloy; and
an inlet-mixer configured to connect with the diffuser, the inlet-mixer having a surface coated with a second hardfacing alloy different from the first hardfacing alloy.

2. The slip joint of claim 1, wherein the first hardfacing alloy is a cobalt-based alloy and the second hardfacing alloy is a cobalt-free alloy.

3. The slip joint of claim 2, wherein the first hardfacing alloy is a cobalt-based hardfacing alloy and the second hardfacing alloy is an iron-based hardfacing alloy.

4. The slip joint of claim 2, wherein the first hardfacing alloy is a cobalt-based hardfacing alloy and the second hardfacing alloy is a nickel-based hardfacing alloy.

5. A jet pump inlet-mixer for a boiling water reactor (BWR) jet pump assembly comprising:
at least one diffuser having a surface coated with a first hardfacing alloy;
at least one inlet-mixer configured to connect with the at least one diffuser, the at least one inlet-mixer having a surface coated with a second hardfacing alloy different from the first hardfacing alloy;
a riser adjacent to the at least one inlet-mixer; and
a restrainer bracket configured to encircle the at least one inlet-mixer.

6. The jet pump inlet-mixer of claim 5, wherein the at least one inlet-mixer includes two inlet-mixers, and the at least one diffuser includes two diffusers corresponding with the two inlet-mixers.

7. The jet pump inlet-mixer of claim 6, wherein the riser is located between the two inlet-mixers.

8. The jet pump inlet-mixer of claim 5, wherein the first hardfacing alloy is a cobalt-based alloy and the second hardfacing alloy is a cobalt-free alloy.

9. The jet pump inlet-mixer of claim 8, wherein the first hardfacing alloy is a cobalt-based alloy and the second hardfacing alloy is an iron-based hardfacing alloy.

10. The jet pump inlet-mixer of claim 8, wherein the first hardfacing alloy is a cobalt-based alloy and the second hardfacing alloy is a nickel-based hardfacing alloy.

11. A method of manufacturing a jet pump inlet-mixer for a boiling water reactor (BWR) jet pump assembly, the method comprising:
coating a surface of a diffuser that forms an interface with an inlet-mixer with a first hardfacing alloy;
coating the inlet-mixer that forms the interface with the diffuser with a second hardfacing alloy different from the first hardfacing alloy;
providing a riser adjacent to the inlet-mixer; and
attaching a restrainer bracket to the inlet-mixer.

12. The method of claim 11, wherein the first hardfacing alloy is a cobalt-based alloy and the second hardfacing alloy is a cobalt-free alloy.

13. The method of claim 12, wherein the first hardfacing alloy is a cobalt-based alloy and the second hardfacing alloy is an iron-based hardfacing alloy.

14. The method of claim 12, wherein the first hardfacing alloy is a cobalt-based alloy and the second hardfacing alloy is a nickel-based hardfacing alloy.

15. The method of claim 11, wherein connecting the inlet-mixer to the diffuser includes connecting two inlet-mixers to two diffusers corresponding with the two inlet-mixers.

16. The method of claim 15, wherein the providing the riser includes providing the riser between the two inlet-mixers.

17. The method of claim 11, wherein coating the inlet-mixer that forms the interface with the diffuser includes coating the inlet-mixer that forms the interface with the diffuser with the second hardfacing alloy using a plasma arc transfer (PTA) welding method.
